(19) United States
(12) Patent Application Publication
(10) Pub. No.: US 2017/0255795 A1
(43) Pub. Date: Sep. 7, 2017

(54) Application control system and method for a personal computing devices

(71) Applicant: APPDOME LTD., Tel Aviv (IL)

(72) Inventors: Avner Yehuda, Ramat Gan (IL); Meir Tsvi, Tel Aviv, IL (US)

(73) Assignee: APPDOME LTD., Tel Aviv (IL)

(21) Appl. No.: 14/578,536

(22) Filed: Dec. 22, 2014

(51) Int. Cl. G06F 21/62; G06F 9/54

(52) U.S. Cl. CPC G06F 21/6281; G06F 9/546; G06F 2221/2149

(57) ABSTRACT

In the new personal computing devices, smart phones and tablets, there is a huge variety of applications from multiple sources. The quality and security of these applications is unknown and it is not under the control of the user or the company the user is working for. Controlling what an application can do with data on such devices is impossible due to the number of applications s and the sources from which they are originating. The present invention will describe a method for providing a data protection under such conditions, especially for corporate data.

There are several known mechanisms to protect data in a computing environment, such as described in patent application 13/846,953 and patent application 20100175104.

### BACKGROUND

Under these mechanisms, a certain known system call can be converted to a call to another address for all applications. Either the address at a known jump table is modified, or the target is overloaded. A software driver at the target address can examine the application and the usage conditions and decide how to handle the original call.

This is used for debug and protection purposes.

This solution has two problems. First there will be an examination overhead for all applications—including those which are not required to go through this process.

Second, there is a privacy issue—personal data may be exposed to a corporate examination software.

### SUMMARY

Each user device application will be examined using relevant information.

It will be decided per application is it needs protection, and is yes for what system calls.

A wrapping applet will be prepared per application requiring protection which will convert relevant system calls to a call to an application control driver, which will examine the application, the data and the usage conditions and will decide how to handle the original call for service.

### BRIEF DESCRIPTION OF THE DRAWINGS

FIG. 1 Describes the wrapper applet preparation system

FIG. 2 Described the application software system in a personal computing device

### DETAILED DESCRIPTION

Under this invention, a mechanism for controlling the behavior of the applications on the user's device is described. Original application calls can be turned of or converted to other calls. The impact of the original application can be cancelled or modified.

This will allow a range of protection capabilities for mobile devices—per the user request or company the user is working for.

The purpose of this invention is to provide protection to data in a mobile device—the protection is preventing undesired operations such as printing, emailing or modifying the data.

The original application is not modified.

The system and method are based on preparing wrapping applets to the applications of interest.

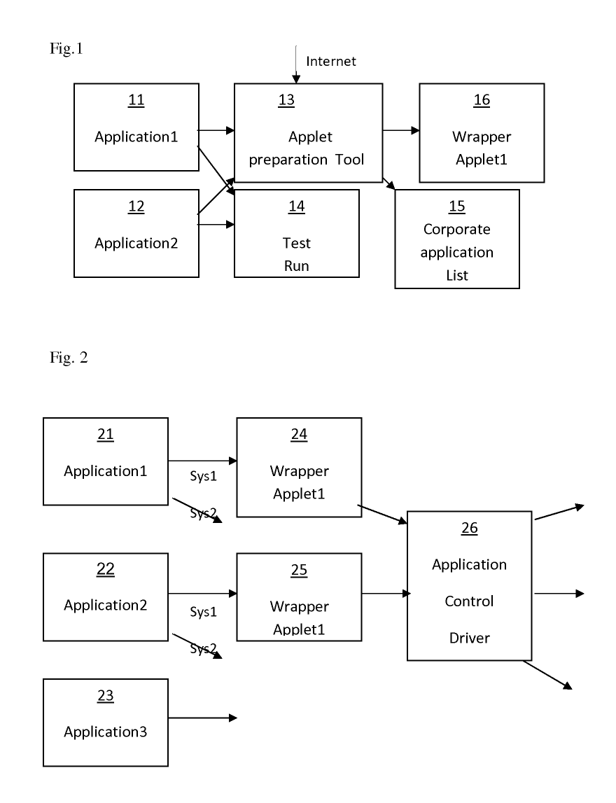

FIG. 1 is a description of the applet preparation method and system.
1. A list of protected operations will be prepared—this can be printing, mailing, viewing a file, modifying a file
2. A list of protected applications (e.g. corporate) corporate applications 15 will be prepared.
3. All applications 11 and 12 will be examined by the Applet preparation tool 13.
4. The tool 13 will examine the protected application list 15 and internet information on the applications. It will detect what operations are executed by the application.
5. The tool 13 may activate a test run tool 14 and examine the source and the output of a tested application.
6. Based on the above, the tool will decide if an applet is required for this application.
7. For application1 an apple will be prepared—for application2 it will not be prepared. The prepared applet will be ready to intercept certain system calls and generate a different system call or software call instead of the original call.

FIG. 2 is describing the system behavior with an applet in run time.

Application1 21 and application 2 22 and application 3 23 are issuing system calls.

Each will issue two type of calls, Sys1 and Sys2.

Application 3 does not have an applet prepared for it and all its system calls will be handled by the system without any intervention.

Applets 24 and 25 will wake up upon the launch of applications 21 and 22 and will prepare system examination for the address of Sys1 call. Nothing for Sys2.

Sys2 calls of the applications will proceed uninterrupted.
1. Sys1 call will wake up the relevant applet 24 or 25 which upon wake up will call application control driver 26.
2. The control driver 26 will check the application request, will check the relevant data, user information, location information and will decide is the system call can go as is.
3. If not, it will decide if to ignore the call, convert it to a call to another software driver (system or processing) and may issue a message to the user.

What is claimed is :

1. A method where certain system calls issued by a specific application may be changed to other system calls or other software calls

2. A method as in claim 1 where the same calls from other application will proceed uninterrupted

3. A method as in 1 where a wrapping applet for system call diversion is prepared per relevant applications.

4. A method as in claim 3 where the wrapping applet will intercept certain system calls

5. A method as in claim 3 where the wrapping applet may divert the system call to a different system call or a call to another software

6. A method as in claim 3 where the list of system calls to be diverted is selected based on a list of protected operations.

7. A method as in claim 3 where the list of applications to be protected is based on a list of protected applications

8. A method as in claim 3 list of applications to be protected is based on internet information

9. A method as in claim 3 list of applications to be protected is based on the results of a test run of applications
